(19) United States
(12) Patent Application Publication
(10) Pub. No.: US 2026/0078311 A1
(43) Pub. Date: Mar. 19, 2026

(54) ACTIVELY COOLED SCREW FEEDER FOR GASIFICATION REACTORS

(71) Applicant: ARIES CLEAN TECHNOLOGIES LLC, Franklin, TN (US)

(72) Inventors: Mark Bauer, Franklin, TN (US); Renus C. Kelfkens, Longmont, CO (US); Trevin Berger, Schnecksville, PA (US)

(21) Appl. No.: 19/400,474

(22) Filed: Nov. 25, 2025

Related U.S. Application Data
(63) Continuation-in-part of application No. 18/303,561, filed on Apr. 19, 2023, now Pat. No. 12,510,295.
Application No. 18/303,561 is a continuation-in-part of application No. 17/676,112, filed on Feb. 18, 2022, now Pat. No. 11,661,559.
Application No. 17/676,112 is a continuation-in-part of application No. 16/922,824, filed on Jul. 7, 2020, now Pat. No. 11,279,894.
Application No. 16/922,824 is a continuation of application No. 16/801,834, filed on Feb. 26, 2020, now Pat. No. 10,738,249.
Application No. 16/801,834 is a continuation-in-part of application No. 16/723,538, filed on Dec. 20, 2019, now Pat. No. 10,696,913.
Application No. 16/723,538 is a continuation-in-part of application No. 16/445,118, filed on Jun. 18, 2019, now Pat. No. 10,611,973.

(51) Int. Cl. C10J 3/46; B01J 8/18; C02F 11/10; C02F 11/12; C02F 11/121; C10J 3/30; C10J 3/48; C10J 3/84; C10K 1/02

(52) U.S. Cl. CPC C10J 3/466; B01J 8/1809; B01J 8/1827; C02F 11/10; C10J 3/482; C10J 3/84; C10K 1/026; B01J 2208/00893; B01J 2208/00902; C02F 11/12; C02F 11/121; C10J 3/30; C10J 2200/15; C10J 2200/158; C10J 2300/0909; C10J 2300/0916; C10J 2300/0923; C10J 2300/0956; C10J 2300/1643; C10J 2300/1807; Y02P 20/129; Y02W 10/40; Y10T 29/49

(57) ABSTRACT

Apparatuses, systems, and associated methods relate to actively cooling and transporting a fuel to a gasification reactor vessel. An actively cooled gasifier screw feeder can include a screw feeder having a first coolant path arranged therethrough and arranged to actively transport the fuel, a sleeve arranged in coaxial relation and about the screw feeder having a second coolant path arranged therethrough, a coolant reservoir arranged to receive, store, and supply a coolant to the first and second coolant paths, and a coolant pump in operative communication with the coolant reservoir and arranged to pump the coolant. The actively cooled gasifier screw feeder is configured to actively cool and feed the fuel into the gasification reactor vessel at a fuel feed rate based upon a type of the fuel and during steady-state operation of the gasification reactor vessel.

### CROSS REFERENCE TO RELATED APPLICATIONS

This Application is a Continuation-in-part of U.S. application Ser. No. 18/303,561 filed Apr. 19, 2023, which is a Continuation-in-part of U.S. application Ser. No. 17/676,112 filed Feb. 18, 2022 (now U.S. Pat. No. 11,661,559 issued May 30, 2023), which is a Continuation-in-part of U.S. application Ser. No. 16/922,824 filed Jul. 7, 2020 (now U.S. Pat. No. 11,279,894 issued Mar. 22, 2022), which is a Continuation of U.S. application Ser. No. 16/801,834 filed Feb. 26, 2020 (now U.S. Pat. No. 10,738,249 issued Aug. 11, 2020), which is a Continuation-in-part Application of U.S. application Ser. No. 16/723,538 filed Dec. 20, 2019 (now U.S. Pat. No. 10,696,913 issued Jun. 30, 2020), which is a Continuation-in-part Application of U.S. application Ser. No. 16/445,118 filed Jun. 18, 2019 (now U.S. Pat. No. 10,611,973 issued Apr. 7, 2020), all of which are hereby incorporated by reference herein in their entirety, for all purposes.

### FIELD

The present disclosure relates in general to the field of feedstock disposal including sewage treatment (SST), municipal solid waste (MSW) management, wood waste (WW) processing, refuse derived fuels (RDF) treatment, Automotive Shredder Residue (ASR) and non-recyclable plastics disposal (NRP). The present disclosure is applicable to various markets, including but not limited to, municipalities, landfill operators that land rehabilitation and clean up, waste generators, wastewater treatment facilities, agricultural waste generators, private waste service companies and entrepreneurs invested in renewable energy.

### BACKGROUND

The fluidized bed or bubbling type bed gasifier includes a feeder system for biosolids that is designed for a single specific feedstock. It is a common practice in the industry that these gasification systems have similar feeder devices but require specialized design features to accommodate specific feedstock related to their respective process conditions and handling requirements. Moreover, when attempting to apply generic designs to feeder devices, various problems become apparent requiring specific solutions that are often cumbersome (e.g., multiple internal bearings, complicated vapor/gas seals, etc.), expensive (e.g., requiring multiple service operations per day to remove clogs and/or frequent reactor shutdowns to perform maintenance), and possibly dangerous (e.g., self-heating/ignition of biosolids in some feeder designs). Accordingly, a need has been identified for a feeder device that mitigates these and other problems apparent in the art of feeders in gasification reactor systems.

### SUMMARY

In the present disclosure, FIGS. 10-16 are newly presented and FIGS. 1-9 were previously disclosed.

Apparatuses, systems, and associated methods relate to actively cooling and transporting a fuel to a gasification reactor vessel. An actively cooled gasifier screw feeder can include a screw feeder having a first coolant path arranged therethrough and arranged to actively transport the fuel, a sleeve arranged in coaxial relation and about the screw feeder having a second coolant path arranged therethrough, a coolant reservoir arranged to receive, store, and supply a coolant to the first and second coolant paths, and a coolant pump in operative communication with the coolant reservoir and arranged to pump the coolant. The actively cooled gasifier screw feeder is configured to actively cool and feed the fuel into the gasification reactor vessel at a fuel feed rate based upon a type of the fuel and during steady-state operation of the gasification reactor vessel.

### BRIEF DESCRIPTION OF THE DRAWINGS

FIG. 1 shows a side view of a gasifier reactor and schematic block diagram illustrating an embodiment of the feeder system configuration for bio-feedstocks.

FIG. 2 shows a schematic side view illustrating a fluidized bed gasifier in accordance with an embodiment of the invention.

FIG. 3 shows a perspective view illustrating a tuyere type gas distributor of the gasifier in accordance with an embodiment of the invention.

FIG. 4 shows a schematic side view illustrating a mid-size non-limiting example of a gasifier's internal dimensions in accordance with an embodiment of the invention.

FIG. 5 shows a schematic side view illustrating a smaller non-limiting example of a gasifier's internal dimensions in accordance with an embodiment of the invention.

FIG. 6 shows a schematic side view illustrating a larger non-limiting example of a gasifier's internal dimensions in accordance with an embodiment of the invention.

FIG. 7 shows a schematic side view illustrating the larger scaled up fluidized bed gasifier of FIG. 6 in accordance with an embodiment of the invention.

FIG. 8A shows a cut away perspective view illustrating a pipe gas distributor of the gasifier in accordance with an embodiment of the invention.

FIG. 8B shows a side elevational view illustrating a pipe gas distributor of the gasifier in accordance with an embodiment of the invention.

FIG. 9 shows a perspective view of an actively cooled gasifier feeder system arranged to be connected to a gasifier in accordance with an embodiment of the invention.

FIG. 10 shows a top view of multiple actively cooled gasifier feeder systems and a single gasifier system with multiple feed points in accordance with an embodiment of the invention.

FIG. 11 shows a side view of the actively cooled gasifier feeder system with a cut away view of a gasifier to which the feeder system is attached in accordance with an embodiment of the invention.

FIG. 12 shows a top view of the actively cooled gasifier feeder system arranged to be connected to a gasifier in accordance with an embodiment of the invention.

FIG. 13A shows an elevation view of an actively cooled gasifier screw feeder in accordance with an embodiment of the invention.

FIG. 13B shows a cross-sectional view of the actively cooled gasifier screw feeder in accordance with an embodiment of the invention.

FIG. 13C shows an end-on cut-away view of the actively cooled gasifier screw feeder in accordance with an embodiment of the invention.

FIG. 14 shows a perspective cut-away view of a screw feeder with hollow flights in accordance with an embodiment of the invention.

FIG. 15 shows a perspective cut-away view of a screw feeder arranged in coaxial relation with an annular cooling sleeve in accordance with an embodiment of the invention.

FIG. 16 is a simplified schematic of a gasification reactor system fed with an actively cooled gasifier screw feeder in accordance with an embodiment of the invention.

### DETAILED DESCRIPTION

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention. Reference will now be made in detail to the various exemplary embodiments of the present invention, which are illustrated in the accompanying drawings.

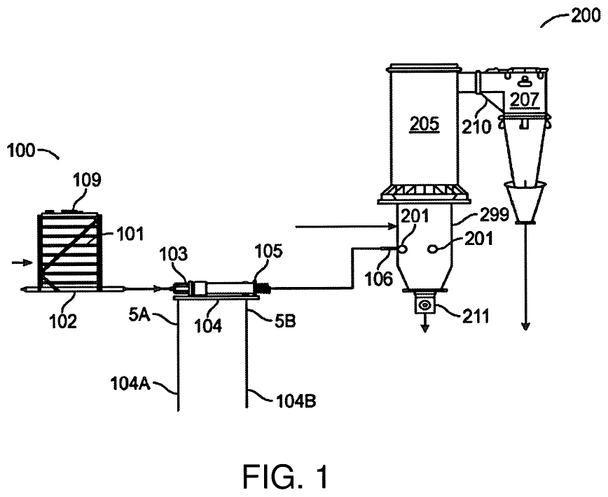

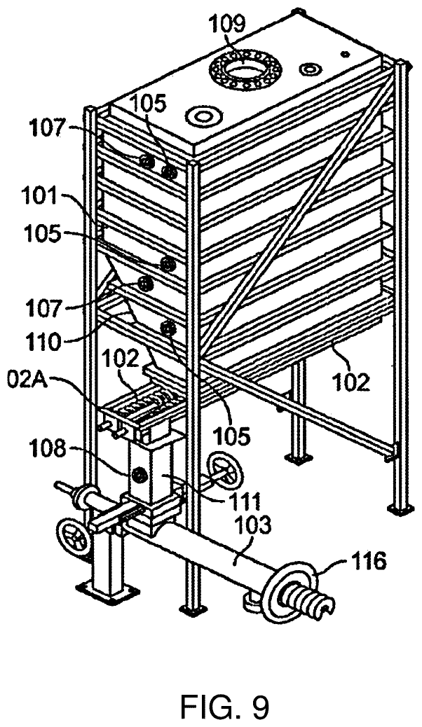

FIG. 1 shows a side view of a gasifier reactor and a schematic diagram illustrating an embodiment of the feeder system 100 configuration for feedstocks which is generally received in a vertically oriented feed vessel 101 meeting industry standard feedstock supply specifications. The system comprises one or more feed vessels 101 each operably connected to a live bottom screw feeder 102. In one embodiment, the feed vessel is rectangular shaped having an upper horizontal side with a feed vessel port 109, an open bottom lower horizontal side, four vertical sides comprising a right side, left side front side and back side; wherein at least one of its four vertical sides is angled at least 60 degrees 110 (shown in FIG. 9) from the horizontal to facilitate proper flow of bio-feedstock materials that have different and/or variable flow properties. In one embodiment, the live bottom screw feeder 102 is positioned below and parallel to the lower horizontal side of the feed vessel 101 and extends beyond the right and left vertical sides of the feed vessel 101 as shown in FIGS. 1 and 9-11. The vessel also provides for aeration mechanisms such as provided by aeration ports 107 (shown in FIG. 9) and or removable bridge breakers (not shown) that are inserted on the interior of the feed vessel 101 to assist with continuous flow. The live bottom screw feeder 102 is conventional industry equipment selected for their ability to transport multiple kinds of feedstock and as such is not limited to sewage sludge, municipal solid waste, wood waste, refuse derived fuels, automotive shredder residue and non-recyclable plastics including blends of two or more biosolids feed stocks such as wood waste plus biosolids.

Screw feeder 102 also called screw conveyors and are used to control the flow rate of both free and non-free flowing, bulk material from a bin, silo or hopper. Live bottom feeders are specifically designed to convey and meter large quantities of materials in a very efficient manner. During operation the inlet section of the screw trough 102A is designed to be flooded with a selected material. The screw under the inlet can be modified to convey a metered amount of material per revolution of the screw. Modifications include but are not limited to in the flighting diameter, pitch, pipe diameter, trough shape. Screws with uniform diameter and pitch will convey material from the rear of the inlet opening to the front. The drives on screw feeders attached to the rear end, are usually variable speed, so that the discharge from a bin, hopper or feed vessel 101 that falls onto the screw feeder 102 and trough 102A can be adjusted, as required, to stay within a prescribed range. Depending on the number of screws across the bottom of the bin, hopper or feed vessel 101, there may be one drive for all the screws, several drives with the screws driven in-groups or individual drives for each screw. In one embodiment, the live bottom screw feeder 102 is configured to convey the material from the feed vessel 101 in two different directions to one of two or more secondary transfer screw feeders 103 as shown in FIG. 9. Accordingly to embodiments of the invention, the secondary transfer screw feeders 103 may be arranged as actively cooled gasifier screw feeders having two or more coolant paths.

The biosolids are transferred by gravity from the live bottom screw feeder 102 through an open bottom chute 111 and onto a secondary transfer screw feeder 103 that conveys the material to a feed nozzle 106 operably connected such as by a flange to flange connection to a fuel feed inlet 201 located on the gasifier reactor vessel 299. In one embodiment, the secondary transfer screw 103 is configured perpendicular to the live bottom screw feeder 102 as shown in FIGS. 1 and 9-11. The secondary transfer screw 103 may be equipped with annular sleeve 104 with a coolant supply 104A and a coolant return 104B to maintain a feedstock temperature between 60° F.-200° F. This feature further expands the types of feedstock that can be conveyed into a gasifier reactor. Screw feeders 102 can be substituted with other industry feeders or pressurized pneumatic conveyors. Pressurized pneumatic conveyors would allow the invention to be used in and with a pressurized gasification system and other transfer designs. All screw feeders 102 and transfer screw feeders 103 are variable speed and motor operated. Although it is possible in another embodiment that the screw feed can be manually operated as with a crank.

In one embodiment, the live bottom screw feeder 102 can operate to direct the flow of feedstock in a single direction. In another embodiment, the screw feeder 102 can operate to direct flow of feedstock in two different directions. The feedstock can be fed into a gasifier reactor vessel 299 from more than one feed vessel 101 through multiple fuel feed inlets 201 located on the gasifier reactor vessel 299. A live bottom screw feeder 102 may therefore feed two separate transfer screw feeders 103; but the transfer screw feeder 103 may also connect and feed another secondary or even tertiary transfer screw feeder 103 (not shown). In one embodiment, the secondary transfer screw 103 is configured perpendicular to the live bottom screw feeder 102 and perpendicular to another secondary transfer screw 103 that conveys the material to a feed nozzle 106 operably connected such as by a flange to flange connection to a fuel feed inlet 201 located on the gasifier reactor vessel 299 (not shown). The feed vessel 101 and each screw feeder 102 and 103 connection transfer the biosolids by gravity through an open bottom chute 111 onto the connecting screw feeder until the screw feeder 103 terminates and mechanically connects to the fluidized fuel inlets 201 on the gasifier reactor vessel 299.

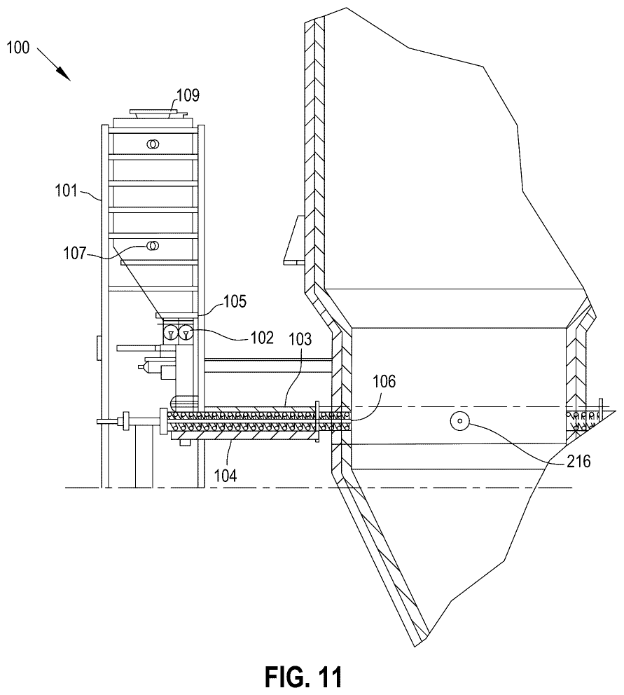

The feed vessels 101 may also be sized such that appropriately distributed volumes of feedstock are maintained entering the gasifier through multiple feed ports. The fuel feed inlets 201, also called feed ports, may be placed all around the gasifier vessel reactor 299 to ensure a continuous feed of fuel into the gasifier system 200. The feed vessel 101 inventory may be controlled through load cells or level sensors 105 (shown on FIGS. 9 and 11). Particle size and moisture of the feedstock may be measured upstream of and on route to the feed vessel port 109 to ensure optimum control and performance output of the gasifier system 200.

In one embodiment, the feeder system 100 is capable of receiving and processing multiple feedstocks prepared to a size up to one inch with an optimal range between 1/16 and ¼ inches. A key requirement of this embodiment is prepping the feedstock to a uniform size, moisture content and quality which is achieved through conventional processes. Prepared feedstock is then introduced into the vessel feed port 109 of the universal feeder vessel 101 and ultimately the gasification reactor vessel 299 for gasification.

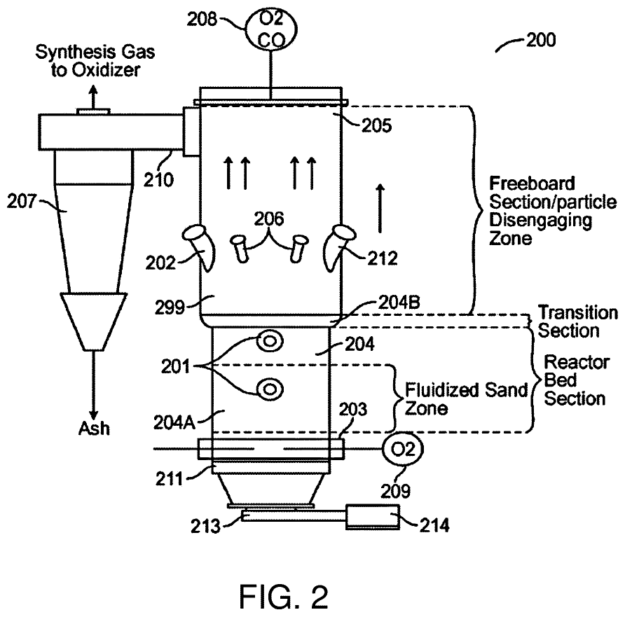

FIG. 2 shows an embodiment of a bubbling type fluidized bed gasifier 200. In one embodiment, the invention is mechanically connected to a standardized feeder system 100 (shown in FIG. 1) which is designed for a gasifier 200 that enables different feedstock material to be fed into existing gasification reactor vessel 299 without having to custom design a feed system for or integrate a custom feeder system into the gasifier system 200. In one embodiment, the bubbling fluidized bed gasifier 200 will include a reactor 299 operably connected to the feeder system 100 as integral part of a standard gasifier system 200.

In continued reference to FIG. 2, the bubbling fluidized bed gasifier 200 will include a reactor 299 operably connected to a feeder system 100 (shown in FIG. 1) as an extended part of a standard gasifier system 200. In one embodiment, the gasifier 200 includes a reactor vessel 299 having a fluidized media bed 204A, such as but not limited to quartz sand, that is in the base of the reactor vessel and called the reactor bed section 204. In one embodiment, the fluidized sand is a zone that has a temperature of 1150-1600° F. Located above the reactor bed section 204 is a transition section 204B and above the transition section 204B is the freeboard section 205 of the reactor vessel 299. Fluidizing gas consisting of air, flue gas, pure oxygen or steam, or a combination thereof, is introduced into the fluidized bed reactor 299 to create a velocity range inside the freeboard section 205 of the gasifier 200 that is in the range of 0.1 m/s (0.33 ft/s) to 3 m/s (9.84 ft/s). The biosolids are heated inside the fluidized bed reactor to a temperature range between 900° F. and 1700° F. in an oxygen-starved environment having sub-stoichiometric levels of oxygen, e.g., typically oxygen levels of less than 45% of stoichiometric.

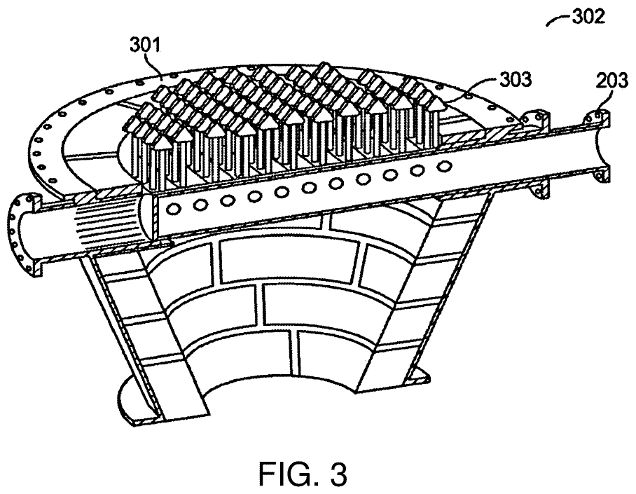

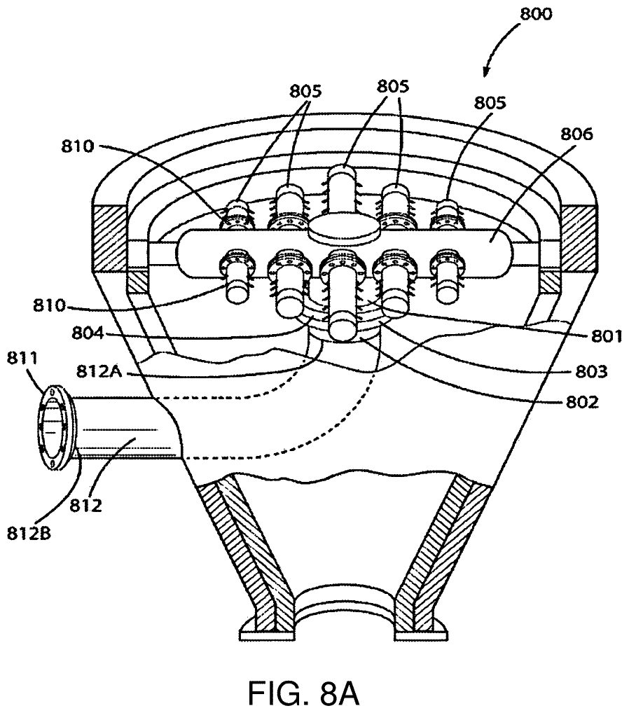

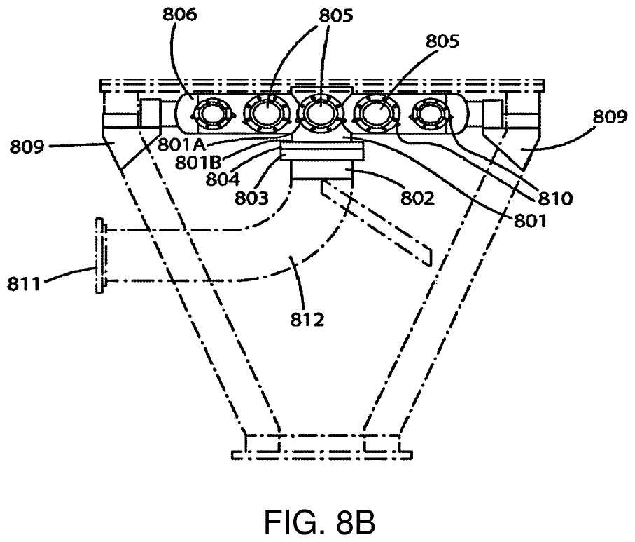

The reactor fluidized bed section 204 of a fluidized bubbling bed gasifier 200 is filled with a fluidizing media 204A that may be a sand (e.g., quartz or olivine), or any other suitable fluidizing media known in the industry. Feedstock such as, but not limited to dried biosolids, is supplied to the reactor bed section 204 through fuel feed inlets 201 at 40-250° F. In one embodiment, the feedstock is supplied to the reactor bed section 204 through fuel feed inlets 201 at 215° F.; with the gas inlet 203 in the bubbling bed receiving an oxidant-based fluidization gas such as but not limited to e.g., air. In one embodiment, the air could be enriched air, or a mix of air and recycled flue gas, etc. The air is not pre-heated, it is fed at ambient conditions. The bed is heated up with natural gas and air combustion from a start-up burner and when the bed reaches its ignition temperature for gasification the reactions takes off and is self-sustaining so long as feed carbon and oxygen continue to react. The fluidization gas is fed to the bubbling bed via a gas distributor, such as shown in FIGS. 3 and 8A-B. An oxygen-monitor 209 may be provided in communication with the fluidization gas inlet 203 to monitor oxygen concentration in connection with controlling oxygen levels in the gasification process. An inclined or over-fire natural gas burner (not visible) located on the side of the reactor vessel 299 receives a natural gas and air mixture via a port 202. In one embodiment, the natural gas air mixture is 77° F. which can be used to start up the gasifier and heat the fluidized bed media 204A. When the minimum ignition temperature for self-sustaining of the gasification reactions is reached (˜900° F.), the natural gas is shut off. View ports 206 and a media fill port 212 are also provided.

In one embodiment, a freeboard section 205 is provided between the fluidized bed section 204 and the producer gas outlet 210 of the gasifier reactor vessel 299. As the biosolids thermally decompose and transform in the fluidized bed media section (or sand zone) into producer gas and then rise through the reactor vessel 299, the fluidizing medium 204A in the fluidized bed section 204 is disentrained from the producer gas in the freeboard section 205 which is also known as and called a particle disengaging zone. A cyclone separator 207 may be provided to separate material exhausted from the fluidized bed reactor 299 resulting in clean producer gas for recovery with ash exiting from the bottom of the cyclone separator 207 alternatively for use or disposal.

An ash grate 211 may be fitted below the gasifier vessel for bottom ash removal. The ash grate 211 may be used as a sifting device to remove any large inert, agglomerated or heavy particles so that the fluidizing media and unreacted char can be reintroduced into the gasifier for continued utilization. In one embodiment, a valve such as but not limited to slide valve 213 which is operated by a mechanism to open the slide valve 214 is located beneath the ash grate 211 to collect the ash. In one embodiment, a second valve 213 and operating mechanism 214 (no shown) are also located below the cyclone separator 207 for the same purpose. That is as a sifting device to remove any large inert, agglomerated or heavy particles so that the fluidizing media and unreacted char can be reintroduced into the gasifier for continued utilization. In one embodiment, the ash grate 211 may be a generic solids removal device known to those of ordinary skill in the art. In another embodiment, the ash grate 211 may be replaced by or combined with the use of an overflow nozzle.

A producer gas control system 208 monitors oxygen and carbon monoxide levels in the producer gas and controls the process accordingly. In one embodiment a gasifier feed system 100 feeds the gasifier reactor 299 through the fluidized fuel inlets 201. In one embodiment, the gasifier unit 200 is of the bubbling fluidized bed type with a custom fluidizing gas delivery system and multiple instrument control. The gasifier reactor 299 provides the ability to continuously operate, discharge ash and recycle flue gas for optimum operation. The gasifier reactor 299 can be designed to provide optimum control of feed rate, temperature, reaction rate and conversion of varying feedstock into producer gas.

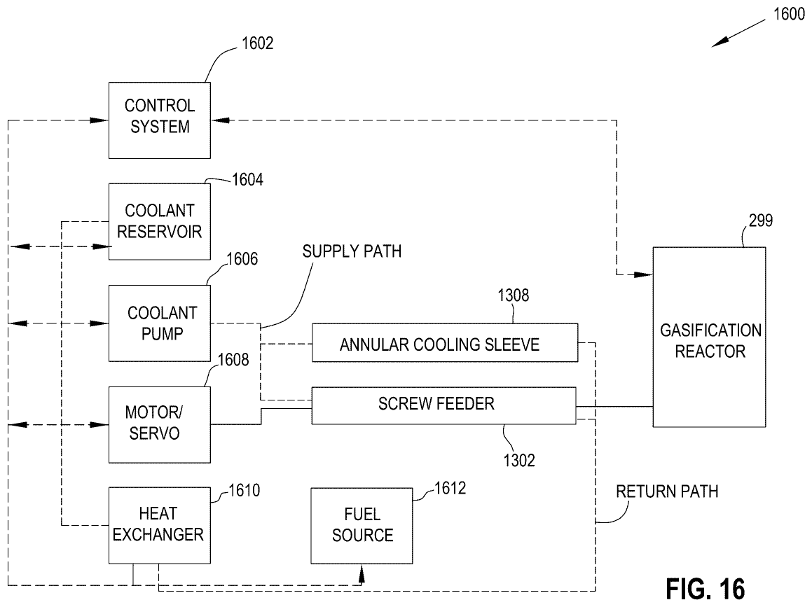

A number of thermocouple probes (not shown) are placed in the gasifier reactor 299 to monitor the temperature profile throughout the gasifier. Some of the thermal probes are placed in the fluidized bed section 204 of the gasifier rector 299, while others are placed in the freeboard section 205 of the gasifier. The thermal probes placed in the fluidized bed section 204 are used not only to monitor the bed temperature but are also control points that are coupled to the gasifier air system via port 202 in order to maintain a certain temperature profile in the bed of fluidizing media. There are also a number of additional control instruments and sensors that may be placed in the gasifier system 200 to monitor the pressure differential across the bed section 204 and the operating pressure of the gasifier in the freeboard section 205 via a control system (illustrated in FIG. 16). These additional instruments are used to monitor the conditions within the gasifier as well as to control other ancillary equipment and processes to maintain the desired operating conditions within the gasifier and/or the feeder system 100. Examples of such ancillary equipment and processes include but are not limited to the cyclone, thermal oxidizer and recirculating flue gas system, air delivery systems, coolant reservoirs, coolant pumps, motors, servos, and others. These control instruments and sensors are well known in industry and therefore not illustrated.

FIG. 3 shows a perspective cut away side view illustrating a gas distributor 302 of the gasifier in accordance with an embodiment of the invention. A flue gas and air inlet 203 feeds flue gas and air to an array of nozzles 301. Each of the nozzles includes downwardly directed ports inside cap 303 such that gas exiting the nozzle is initially directed downward before being forced upward into the fluidized bed in the reactor bed section 204 (shown in FIG. 2). An optional ash grate 211 under the gasifier may be used as a sifting device to remove any agglomerated particles so that the fluidizing media and unreacted char can be reintroduced into the gasifier for continued utilization. Also shown is a cut away view of the gas inlet 203 in the bubbling bed receiving an oxidant-based fluidization gas such as but not limited to e.g., air.

### Biogasifier Reactor Sizing

The following provides a non-limiting example illustrating computation of the best dimensions for a bubbling fluidized bed gasification reactor in accordance with an embodiment of the invention. The gasifier, in this example, is sized to accommodate two specific operating conditions: The current maximum dried biosolids output generated from the dryer with respect to the average solids content of the dewatered sludge supplied to the dryer from the existing dewatering unit; and the future maximum dried biosolids feed rate that the dryer will have to deliver to the gasifier if the overall biosolids processing system has to operate without consumption of external energy, e.g., natural gas, during steady state operation with 25% solids content dewatered sludge being dried and 5400 lb/hr of water being evaporated from the sludge.

The first operating condition corresponds to the maximum output of dried sewage sludge from the dryer if, e.g., 16% solids content sludge is entering the dryer, and 5400 lb/hr of water is evaporating off the sludge. This corresponds to a biosolids feed rate in the small-scale gasifier of 1,168 lbs/hr of thermally dried biosolids at 10% moisture content entering the gasifier. In one embodiment, a solids content of 16-18% represents the estimated extent of dewatering that is required to make the drying load equal to the amount of thermal energy which can be recovered from the flue gas and used to operate the dryer. If sludge below 16% solids content are processed in the dryer, an external heat source can supplement the drying process. The second operating condition corresponds to the maximum amount of dried biosolids (dried to 10% moisture content) that the drier can produce if 25% solids content dewatered biosolids is fed into the drier. The second condition corresponds to the gasifier needing to process 2,000 lb/hr of 10% moisture content biosolids. In other words, there will be excess heat from feeding biosolids to the gasifier if greater than 20% content of biosolids in the sludge is used.

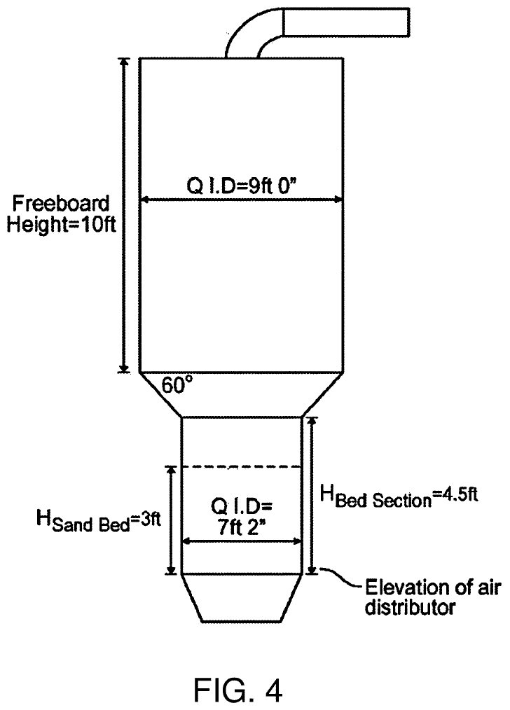

FIG. 4 4 shows a non-limiting example of the gasifier with a reactor freeboard diameter of 9 feet, 0 inches and other internal dimensions in accordance with the invention. The dimensions shown satisfy the operational conditions that are outlined in previous applications. As is known in the art, one factor in determining gasifier sizing is the bed section internal diameter. The role of the bed section of the reactor is to contain the fluidized media bed. The driving factor for selecting the internal diameter of the bed section of the gasifier is the superficial velocity range of gases, which varies with different reactor internal diameters. The internal diameter has to be small enough to ensure that the media bed is able to be fluidized adequately for the given air, recirculated flue gas and fuel feed rates at different operating temperatures, but not so small as to create such high velocities that a slugging regime occurs and media is projected up the freeboard section. The media particle size can be adjusted during commissioning to fine tune the fluidizing behavior of the bed. In the present, non-limiting example, an average media (sand) particle size of about 700 μm was selected due to its ability to be fluidized readily, but also its difficulty to entrain out of the reactor. The most difficult time to fluidize the bed is on start up when the bed media and incoming gases are cold. This minimum flow rate requirement is represented by the minimum fluidization velocity, (“U_{inf}”) values displayed in the previous table.

Another factor in determining gasifier sizing is the freeboard section internal diameter. The freeboard region of the gasifier allows for particles to drop out under the force of gravity. The diameter of the freeboard is selected with respect to the superficial velocity of the gas mixture that is created from different operating temperatures and fuel feed rates. The gas superficial velocity must be great enough to entrain the small ash particles, but not so great that the media particles are entrained in the gas stream. The extent of fresh fuel entrainment should also be minimized from correct freeboard section sizing. This is a phenomenon to carefully consider in the case of biosolids gasification where the fuel typically has a very fine particle size. Introducing the fuel into the side of the fluidized bed below the fluidizing media's surface is one method to minimize fresh fuel entrainment. This is based on the principle that the fuel has to migrate up to the bed's surface before it can be entrained out of the gasifier, and this provides time for the gasification reactions to occur.

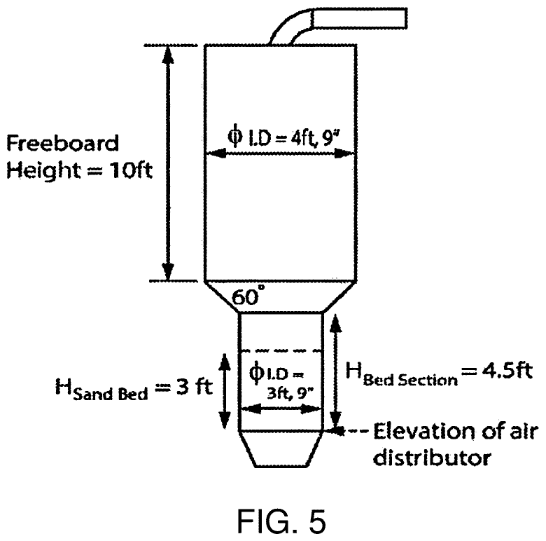

In one non-limiting example shown in FIG. 5, a reactor with freeboard diameter of 4 feet, 9 inches is chosen for smaller volumes of feed of about 24 tons per day but also to maintain gas superficial velocities high enough to entrain out ash but prevent entrainment of sand (or other fluidizing media) particles in the bed.

A further factor in determining gasifier sizing is the media bed depth and bed section height. In general, the higher the ratio of media to fuel in the bed, the more isothermic the bed temperatures are likely to be. Typically, fluidized beds have a fuel-to-media mass ratio of about 1-3%. The amount of electrical energy consumed to fluidize the media bed typically imparts a practical limit on the desirable depth of the media. Deeper beds have a higher gas pressure drop across them and more energy is consumed by the blower to overcome this resistance to gas flow. A fluidizing media depth of 3 feet is chosen in this example shown in FIG. 5, which is based on balancing the blower energy consumption against having enough media in the bed to maintain isothermal temperature and good heat transfer rates. The height of the bed section of the reactor in this non-limiting example is based on a common length-to-diameter aspect ratio of 1.5, relative to the depth of the fluidizing media.

Another factor in determining gasifier sizing is the height of the freeboard section 205. The freeboard section 205 is designed to drop out particles and return it to the bed, under the force of gravity and a reduction of superficial velocity as a result of the larger diameter in the free board section. As one moves up in elevation from the bed's surface, the particle size and density decreases, until at a certain elevation, a level known as the Transport Disengaging Height (TDH) is reached. Above the TDH, the particle density entrained up the reactor is constant. Extending the reactor above the TDH adds no further benefit to particle removal. For practical purposes 10 feet is selected for the height of the freeboard section 205 in this non-limiting example shown in FIG. 5. While the invention has been particularly shown and described with reference to a preferred embodiment in FIG. 5, it will be understood by those skilled in the art that various changes in form and details may be made therein without departing from the spirit and scope of the invention.

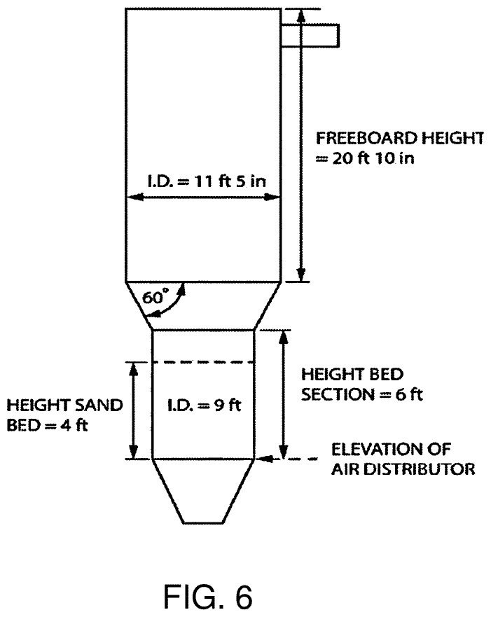

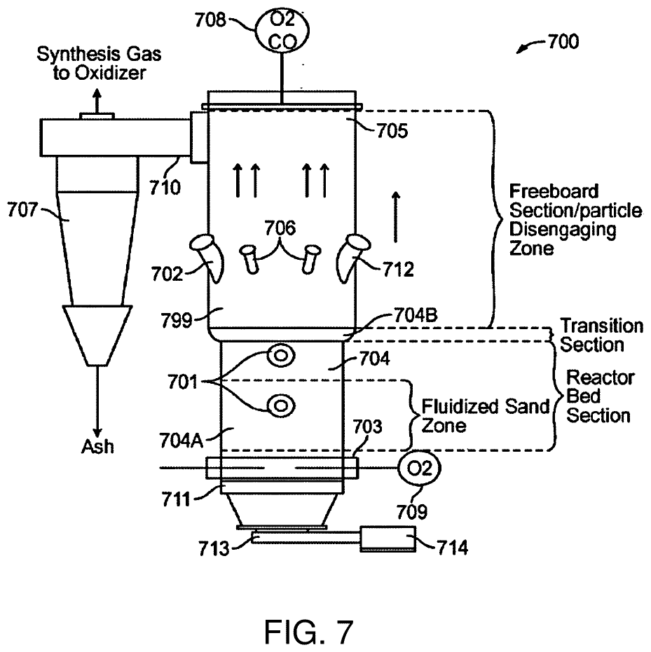

FIG. 6 shows a schematic side view illustrating a larger scaled-up embodiment is provided in which the gasifier internal dimensions are enlarged in accordance with the invention. In this embodiment, the invention illustrates a scaling up or enlargement of the gasifier reactor vessel. In one embodiment, the increase in reactor vessel size has a capacity scale that is at least 4 times larger in processing feedstock volume than the small-scale reactor vessel shown in FIG. 5. For example, the small-scale reactor can process 24 tons per day of feedstock. The large-scale reactor can process more than 40 tons per day with an average of about 100 tons per day of feedstock. At an average of 100 tons per day of feedstock equals an average of at least 4 times that of the small-scale reactor of 24 tons per day which is equal to about 96 tons per day. In one, embodiment, of the scaled-up large format reactor, the multi-tuyere gas distributor shown in FIG. 3 is replaced with a conventional pipe-based fluidization gas distribution system shown in FIGS. 8A-8B. The substitution of the pipe-based distributor 800 simplifies and eliminates the complexity, time and cost associated with the mechanical fabrication of scaling up the multi-tuyere gas distributor design used in the bioreactor unit illustrated in FIG. 3. A conventional pipe-based fluidization gas distribution system allows a single large vessel reactor capable of processing at least 4 times the quantity of feedstock processed in a small-scale reactor. The larger scale reactor illustrated in FIGS. 6-7 has many of the same features as the smaller scaled version illustrated in FIGS. 2 and 5. However, some adjustments to the reactor bed and free-board height are required based on the change in diameter of the reactor bed section. The formula for Transport Disengaging Height (“TDH”) is a function of the change in diameter of the reactor bed section 704 shown in FIG. 7. Specifically, the geometric ratios remain the same to minimize/eliminate performance scale-up risk.

FIG. 6 also shows a non-limiting example illustrating computation of the sample dimensions for sizing the gasifier reactor when it is a bubbling fluidized bed gasification reactor. More specifically, FIG. 6 shows a non-limiting example of the gasifier with a reactor freeboard diameter of 11 feet, 5 inches and other internal dimensions in accordance with the invention. The gasifier, in this example, is sized to accommodate specific design operating conditions for dried biosolids feed rate delivered to the gasifier corresponding to a biosolids feed rate in the large-scale gasifier of 8,333 lb/hr and 7040 lb/hr of thermally dried biosolids at 10% moisture content entering the gasifier.

FIG. 7 shows a scaled-up embodiment of a bubbling type fluidized bed gasifier 700. In one embodiment, the bubbling fluidized bed gasifier 700 will include a reactor 799 operably connected to the feeder system (shown in FIG. 1) as an extended part of the standard gasifier system 700. A fluidized media bed 704A such as but not limited to quartz sand is in the base of the reactor vessel called the reactor bed section 704. In one embodiment, the fluidized sand is a zone that has a temperature of 1150° F.-1600° F. Located above the reactor bed section 704 is a transition section 704B and above the transition section 704B is the freeboard section 705 of the reactor vessel 799. Fluidizing gas consisting of air, flue gas, pure oxygen or steam, or a combination thereof, is introduced into the fluidized bed reactor 799 to create a velocity range inside the freeboard section 705 of the gasifier 700 that is in the range of 0.1 m/s (0.33 ft/s) to 3 m/s (9.84 ft/s). The biosolids are heated inside the fluidized bed reactor to a temperature range between 900° F. and 1600° F. in an oxygen-starved environment having sub-stoichiometric levels of oxygen, e.g., typically oxygen levels of less than 45% of stoichiometric. In another embodiment, the fluidized sand is a zone that has a temperature of 1150° F.-1600° F.

The reactor fluidized bed section 704 of a fluidized bubbling bed gasifier 700 is filled with a fluidizing media 704A that may be a sand (e.g., quartz or olivine), or any other suitable fluidizing media known in the industry. Feedstock such, as but not limited to sludge, is supplied to the reactor bed section 704 through fuel feed inlets 701 at 40-250° F. In one embodiment, the feedstock is supplied to the reactor bed section 704 through fuel feed inlets 701 at 215° F.; with the gas inlet 703 in the bubbling bed receiving an oxidant-based fluidization gas such as but not limited to e.g., gas, flue gas, recycled flue gas, air, enriched air and any combination thereof (hereafter referred to generically as “gas” or “air”). In one embodiment, the air is at about 600° F. The type and temperature of the air is determined by the gasification fluidization and temperature control requirements for a particular feedstock. The fluidization gas is fed to the bubbling bed via a gas distributor, such as shown in FIGS. 3 and 8A-B. An oxygen-monitor 709 may be provided in communication with the fluidization gas inlet 703 to monitor oxygen concentration in connection with controlling oxygen levels in the gasification process. An inclined or over-fire natural gas burner (not visible) located on the side of the reactor vessel 799 receives a natural gas and air mixture via a port 702. In one embodiment, the natural gas air mixture is 77° F. which can be sued to start up the gasifier and heat the fluidized bed media 704A. When the minimum ignition temperature for self-sustaining of the gasification reactions is reached (˜900° F.), the natural gas is shut off. View ports 706 and a media fill port 712 are also provided.

In one embodiment, a freeboard section 705 is provided between the fluidized bed section 704 and the producer gas outlet 710 of the gasifier reactor vessel 799. As the biosolids thermally decompose and transform in the fluidized bed media section (or sand zone) into producer gas and then rise through the reactor vessel 799, the fluidizing medium 704A in the fluidized bed section 704 is disentrained from the producer gas in the freeboard section 705 which is also known as and called a particle disengaging zone. A cyclone separator 707 may be provided to separate material exhausted from the fluidized bed reactor 799 resulting in clean producer gas for recovery with ash exiting the bottom of the cyclone separator 707 alternatively for use or disposal.

An ash grate 711 may be fitted below the gasifier vessel for bottom ash removal. The ash grate 711 may be used as a sifting device to remove any large inert, agglomerated or heavy particles so that the fluidizing media and unreacted char can be reintroduced into the gasifier for continued utilization. In one embodiment, a valve such as but not limited to slide valve 713 which is operated by a mechanism to open the slide valve 714 is located beneath the ash grate 711 to collect the ash. In one embodiment, a second valve 713 and operating mechanism 714 (not shown) are also located below the cyclone separator 207 for the same purpose. That is as a sifting device to remove any large inert, agglomerated or heavy particles so that the fluidizing media and unreacted char can be reintroduced into the gasifier for continued utilization. In one embodiment the ash grate 711 may be a generic solids removal device known to those of ordinary skill in the art. In another embodiment, the ash grate 711 may be replaced by or combined with the use of an overflow nozzle.

A producer gas control 708 monitors oxygen and carbon monoxide levels in the producer gas and controls the process accordingly. In one embodiment, a gasifier feed system (shown in FIGS. 1 and 9-11) feeds the gasifier reactor 799 through the fluidized fuel inlets 701. In one embodiment, the gasifier unit 700 is of the bubbling fluidized bed type with a custom fluidizing gas delivery system and multiple instrument control. The gasifier reactor 799 provides the ability to continuously operate, discharge ash and recycle flue gas for optimum operation. The gasifier reactor 799 can be designed to provide optimum control of feed rate, temperature, reaction rate and conversion of varying feedstock into producer gas.

A number of thermocouple probes (not shown) are placed in the gasifier reactor 799 to monitor the temperature profile throughout the gasifier. Some of the thermal probes are placed in the fluidized bed section 704 of the gasifier rector 799, while others are placed in the freeboard section 705 of the gasifier. The thermal probes placed in the fluidized bed section 704 are used not only to monitor the bed temperature but are also control points that are coupled to the gasifier air system via port 702 in order to maintain a certain temperature profile in the bed of fluidizing media. There are also a number of additional control instruments and sensors that may be placed in the gasifier system 700 to monitor the pressure differential across the bed section 704 and the operating pressure of the gasifier in the freeboard section 205. These additional instruments are used to monitor the conditions within the gasifier as well to as control other ancillary equipment and processes to maintain the desired operating conditions within the gasifier. Examples of such ancillary equipment and processes include but are not limited to the cyclone, thermal oxidizer and recirculating flue gas system and air delivery systems. These control instruments and sensors are well known in the industry and therefore not illustrated.

With reference to FIG. 7, an optional ash grate 711 may be fitted below the gasifier vessel for bottom ash removal. The ash grate 711 may be used as a sifting device to remove any agglomerated particles so that the fluidizing media and unreacted char can be reintroduced into the gasifier for continued utilization. In one embodiment, a slide valve 713 operated by a mechanism to open the slide valve 714 is located beneath the ash grate 711 to collect the ash. In one embodiment, a second slide valve 713 and operating mechanism 714 are located below the cyclone separator 707.

As with the small format fluidized bed gasifier, some unreacted carbon is carried into the cyclone separator 707 with particle sizes ranging from 10 to 300 microns. When the solids are removed from the bottom of the cyclone, the ash and unreacted carbon can be separated and much of the unreacted carbon recycled back into the gasifier, thus increasing the overall fuel conversion to at least 95%. Ash accumulation in the bed of fluidizing media may be alleviated through adjusting the superficial velocity of the gases rising inside the reactor. Alternatively, bed media and ash could be slowly drained out of the gasifier base and screened over an ash grate 711 before being reintroduced back into the gasifier. This process can be used to remove small, agglomerated particles should they form in the bed of fluidizing media and can also be used to control the ash-to-media ratio within the fluidized bed.

With continued reference to FIG. 7, a feedstock such as but not limited to biosolid material can be fed into the gasifier by way of the fuel feed inlets 701 from more than one location on the reactor vessel 799 and wherein said fuel feed inlets 701 may be variably sized such that the desired volumes of feedstock are fed into the gasifier through multiple feed inlets 701 around the reactor vessel 799 to accommodate a continuous feed process to the gasifier. For the present invention and in one embodiment, the number of fuel feed inlets is between 2-4. The minimum number of feed inlets 701 is based, in part, on the extent of extent of back mixing and radial mixing of the char particles in the bed and on the inside diameter of the reactor bed section 704. For bubbling fluidized beds, one feed point could be provided per 20 ft² of bed cross sectional area. For example, and in one embodiment, if the reaction bed section has an internal diameter of 9 ft, the reactor vessel 799 will have at least 3 feed inlets 701 which may be located equidistant radially to maintain in-bed mixing. Feed inlets 701 may be considered all on one level, or on more than one level or different levels and different sizes.

FIG. 8A shows a cut away perspective view illustrating a pipe gas distributor of the biogasifier in accordance with an embodiment of the invention. FIG. 8B shows a side elevational view illustrating a pipe gas distributor of the biogasifier in accordance with an embodiment of the invention. In one embodiment, the invention has a pipe distributor design with a main air inlet 801, said main air inlet 801 having an upper portion 801A and lower portion 801B. In one embodiment, the lower portion 801B is connected a pipe 812 such as but not limited to an elbow or j-pipe. In one embodiment, the lower portion 801B is connected to a pipe 812 using a male mounting seal that is connected to a female mounting seal 803 that is connected to a female mounting stub that is connected to the pipe 812. In one embodiment, the pipe 812 has a proximal end 812A and terminal end 812B wherein the proximal end 812A is mechanically connected to the main air inlet 801 and the terminal end 812B is connected to the gas inlet 703. In one embodiment, the pipe 812B terminal end has a flange 811 to connect to the gas inlet 703.

The upper portion of the main air inlet 801A is aligned with and an opening in a center trunk line 806, said trunk line 806 having at least 10 lateral air branches 805 that are open on one end to the center trunk line and closed on the other end. In one embodiment the lateral air branches 805 are symmetrically spaced on either side of the center trunk line 806. In one embodiment, the lateral air branches 805 are of varying length to fit symmetrically within the diameter of the bottom of the reactor bed 204. In one embodiment, each of the lateral air branches 805 comprise downward pointing gas and air distribution nozzles 810 which are also called, gas and air distribution ports 810. The air distribution nozzles 810 are pointed downward so the air entering from the main air inlet 801 is injected in a downward motion into the cone-shaped bottom of the gasifier reactor 799. In one embodiment the distribution nozzles 810 point downward at an angle such as but not limited to a 45-degree angle. The configuration and general locations of nozzles and components differ from the tuyere design for the smaller reactor vessel in that fewer gas/air distribution nozzles are required in a tuyere design to meet the fluidization requirements and good mixing requirements but still enough to enable the full volume of the fluidizing media material to fluidize when slumped in the bottom cone section of the reactor. This is also an essential part of the reactor.

FIG. 9. shows a perspective view of an actively cooled gasifier feeder system arranged to be connected to a gasifier in accordance with an embodiment of the invention. With reference to FIG. 9 the feedstock is gravity fed from a feed port 109 located on top to the feeder vessel 101. In one embodiment, the vessel 101 is rectangular shaped having three vertical sides and an angled side 110. The angled side 110 has a slope of no less than 60 degrees from the horizontal to facilitate proper flow of bio-feedstock materials that have different and/or variable flow properties. At least one side of the vessel 101 needs to be angled, although the vertical sides can also be between vertical and a have a negative angle between 0 and 15 degrees. The no less than 60-degree angle 110 together with aeration using aeration ports 107 (shown in FIG. 11) and other means such as inserting removable bridge breakers (not shown) located within the vessel 101 can assist with and modulate flow of vary feedstock.

The length of the live bottoms screw 102 and transfer screw 103 may vary and depend in the space available to locate the vessel 101 and distance to the gasifier 200. The transfer screw 103 may be equipped with a cooling sleeve 104 shown in FIG. 11 for feedstock or feedstock combinations that have a recommended minimum flammability temperature that requires the feedstock to be cooled or for general cooling of feedstock due to any other identified need (e.g., based on composition of the feedstock, self-heating of the feedstock, etc.). In one embodiment, the feed system 100 is arranged to actively cool the fuel below a threshold self-heating or pyrolysis initiation temperature. In one embodiment, the feed system 100 includes more than one transfer screw 103 that can operate as metering screws that are then connected to a transfer screw that can operate as a high-speed injection screw conveying the feedstock into the gasifier reactor vessel 299 (not illustrated). In one embodiment, load cells or metering screw systems are used in place of the live bottom screw and transfer screw to control the feed rate to the gasifier.

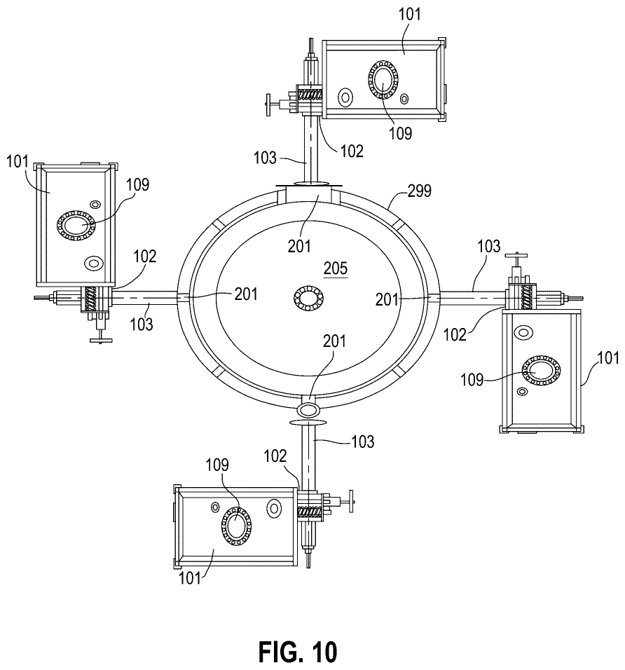

FIG. 10 shows a top view of multiple feeder systems 100 and a single gasifier reactor vessel 299 with sample screw connections and multiple feed points via the fuel feed inlets 201 in accordance with an embodiment of the invention. As shown, up to four individual feeder systems 100 may be integrated with four separate fuel feed inlets 201. In an embodiment with multiple and/or up to four individual feeder systems 100, one or more feeder systems may be offline while the other feeder systems actively provide enough fuel to a reactor vessel to sustain operation. In another embodiment, dual feeder systems 100 may be integrated with the four separate fuel feed inlets 201 through integration of additional transfer screw feeders 103. In an additional embodiment, a single feeder system 100 may be integrated with the four separate fuel feed inlets 201 through integration of additional transfer screw feeders 103. It is noted that the particular arrangement of feeder systems 100 illustrated in FIG. 10 may be varied in many ways without departing from the scope of this disclosure. Furthermore, relative scale and/or length of individual components of feeder systems 100 may be varied to account for installation requirements while still retaining the operational characteristics described herein. Moreover, although illustrated in FIG. 10 as being staggered about a circumference of the reactor vessel 299, multiple feed inlets may also be staggered along the vertical of the gasifier bed section and/or around the circumference of the reactor vessel. Accordingly, embodiments are not limited to staggering on a single plane.

FIG. 11 shows a side view of the actively cooled gasifier feeder system 100 with a cut away view of a gasifier reactor vessel 299 to which the actively cooled gasifier transfer screw 103 of the feeder system 100 is attached via at least fuel feed inlet 201 of the gasifier 200 in accordance with an embodiment of the invention. In one embodiment, the transfer screw 103 terminates at the fuel feed inlet 201. In another embodiment, the transfer screw 103 protrudes into the bed section 204 of the reactor vessel 299. In this embodiment, sample bin capacity is shown as 3.5 tons of feedstock for a single feed vessel with an internal temperature of the feed vessel at 200° F. In one embodiment, the internal operating temperature of the gasifier reactor 299 is about 1200° F. Multiple sensors (not shown) can be included to monitor pressure and temperature within the reactor vessel. One such sensor such as feed level sensors 105. Another embodiment may also include a feed view port 108 located on the open bottom chute 111.

The location of the aeration ports 107 can be variable in size and location and on any side of the vessel. The number of ports 107 can also be increased or decreased depending on the type and number of bridge breaking features and size of the feed vessel 101. Adjustable aeration features that uses either air or an inert gas, assists with avoiding bridging and maintaining flow to the transfer screws 103. The feed vessel 101 terminates in an open bottom chute 111 and a live bottom screw feeder design 102 is located below the chute 111. The screw feeder 102 conveys the feedstock to another open bottom chute 111 that drops the feedstock by gravity directly onto the transfer screw 103. The screw feeder 103 conveys the feedstock either to another transfer screw feeder 103 by the same gravity/chute mechanism or conveys the feedstock to a gasifier reactor 299 via a fluidized fuel feed inlet 201. The connection of the transfer screw 103 to the feed inlet 201 is mechanical such as by a flange 116 to flange 116 connection.

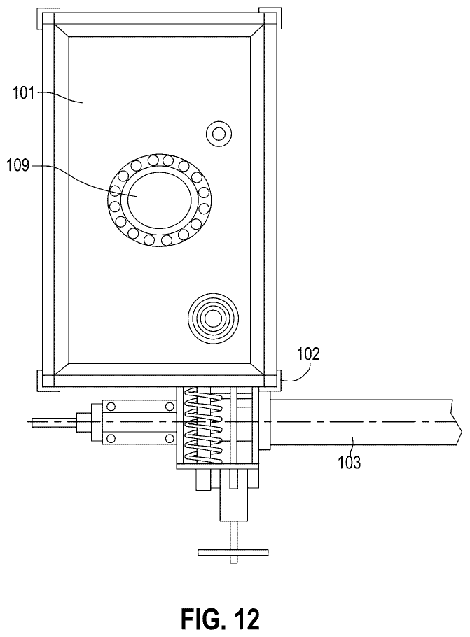

FIG. 12 shows a top view of the actively cooled gasifier feeder system arranged to be connected to a gasifier in accordance with an embodiment of the invention. In FIG. 12, the feed vessel 101 is configured to receive feedstock using the feed vessel port 109. The live bottom screw feeder 102 is operably coupled with the feed vessel 101. The actively cooled gasifier screw feeder 103 is configured to move a feedstock feed from the live bottom screw feeder 102 to a reactor vessel configured to be operably coupled with the actively cooled gasifier screw feeder 103. The reactor vessel may be a gasifier.

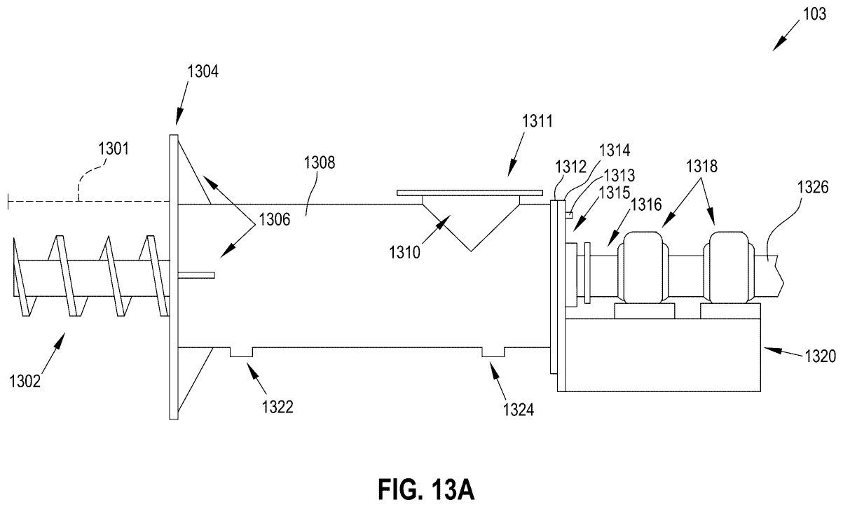

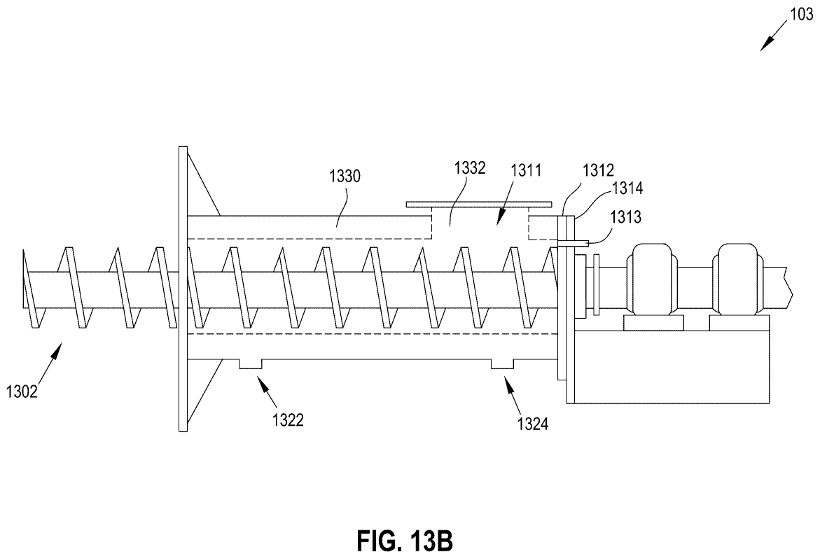

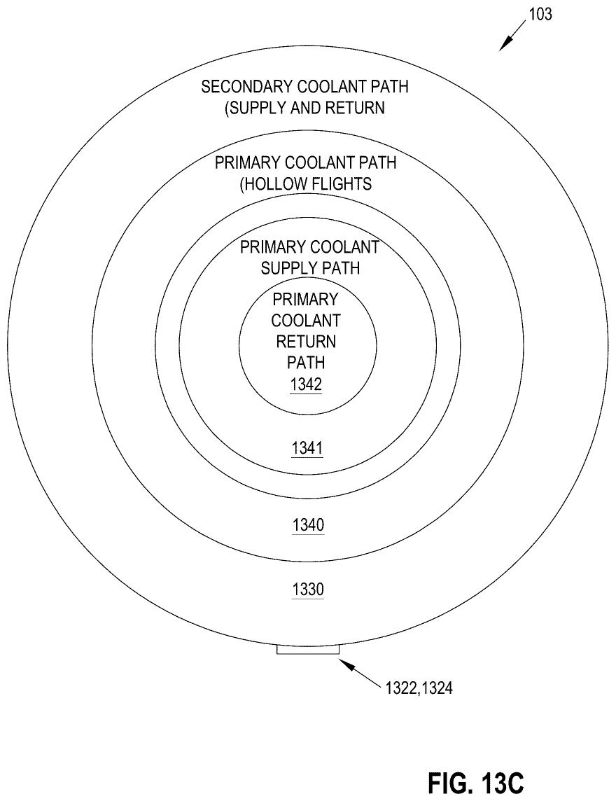

FIG. 13A shows an elevation view of the actively cooled gasifier screw feeder 103 in accordance with an embodiment of the invention. As illustrated, the actively cooled screw feeder 103 comprises a screw feeder 1302 arranged in a coaxial relation with a cooling sleeve 1308. The screw feeder 1302 partially extends or protrudes (i.e., see 1301) beyond a flange 1304 disposed on proximate stiffeners 1306 of the cooling sleeve 1308, such that the protruding portion 1301 may be inset within an appropriate fuel inlet, flange, and/or wall of a reactor vessel. In the illustrated embodiment, the stiffeners 1306 have a triangular profile. However, various geometries of stiffeners may also be appropriate. In one embodiment, four stiffeners 1306 are arranged about a circumference of the sleeve 1308 and abut against the flange 1304. In one embodiment between four and eight stiffeners 1305 are arranged about a circumference of the sleeve 1308 and abut against the flange 1304. More or fewer stiffeners may also be arranged depending upon a final size or circumference of the sleeve 1308 and material choice (e.g., steel, alloy, and/or stainless steel) forming the sleeve 1308.

A fuel feed port 1310 is formed on the cooling sleeve 1308 such that a fuel feed inlet 1311 allows deposition of fuel into the inner diameter of the cooling sleeve 1308, within an inner cavity arranged to contain the screw feeder 1302. In operation, the screw feeder 1302 moves fuel received at the fuel inlet 1311 towards the protruding section 1301 for deposition in a gasification reactor or another screw feeder (not illustrated). It is noted that the illustrated embodiment anticipates a “flooded fill” of the screw cavity, such that there is not air above the screw shaft. Flooding the screw cavity further suppresses or prevents back flow of gases from the gasifier into the actively cooled screw feeder.

The cooling sleeve 1308 may be an annular sleeve in some embodiments. Additionally, the cooling sleeve may be mounted and/or affixed to a substrate 1320 with mounting flange 1314. A screw feeder gas tight shaft seal 1315 may be connected to the mounting bracket 1315 such that an axle or shaft 1316 of the screw feeder 1302 may extend distally through the gas tight seal 1315 and outward from the mounting flange 1314 as well as into the annular cooling sleeve 1308. Additionally, a flange 1312 is mounted on the sleeve 1308 and/or formed on the sleeve 1308. Unbolting the flange 1312 allows the screw assembly 1302 that is fixed to the base 1320 and the double bearings 1318 to be pulled out of the sleeve 1308 for maintenance. It is noted that the sleeve 1308 would stay bolted to the gasifier flange via 1304 during maintenance. In one embodiment, the cooling sleeve 1308, flanges, brackets, and other componentry may be formed from a steel alloy or stainless steel.

Two or more mounting bearings 1318 may be affixed and/or attached to the mounting substrate 1320. Each mounting bearing may allow rotational motion of the cooling sleeve shaft 1316 such that an entirety of the screw feeder 1302 is rotationally mounted to the mounting substrate 1320. In one embodiment, the mounting bearings 1318 are bearings arranged to allow for a cantilever support of the screw feeder 1302 and to allow rotation therein as well as reduce sag of the body of the screw feeder 103 within the cooling sleeve 1308. In some embodiments, the mounting bearings 1318 may be formed of heat resistant material or at least partially formed of heat resistant material. The mounting bearings 1318 may include serviceable components such as bearing races, bearings, and/or lubrication ports for receiving lubricants.

Coolant ports 1322 and 1324 may be formed in the cooling sleeve 1308 such that coolant may be directed into a secondary coolant path defined by the interior and exterior surfaces of the coolant sleeve 1308 (illustrated in FIG. 13B). For example, in operation, as fuel is fed into port 1311 and is moved by screw feeder 1302, coolant may flow into a first coolant port, flow within the secondary coolant path, and exit a second coolant port. In one embodiment, a baffling is arranged within the coolant path 1330 to promote circulation of the coolant therein. Different variations of baffling may be applicable, including horizontally staggered baffling and other baffling arrangements. In one embodiment, the baffling is staggered from a first distal portion of the sleeve 1308 near flange 1312 towards a second distal portion of the sleeve 1308 near flange 1304. In one embodiment, the staggered baffling comprises curved baffles arranged within the hollow cylindrical cavity defining a second coolant path (i.e., see FIG. 13B). As further illustrated, a gas port 1313 is arranged through the flanges 1312 and 1314 such that a gas purge and/or gas fill of the central cavity of the screw feeder 103 is possible. For example, injection of an inert gas such as nitrogen further prevents backflow of gases from the gasifier. The gas port 1313 may include a resealable fitting such that any appropriate gas connection may be made without allowing the contents of the screw feeder 103 to escape. In one embodiment, the gas port 1313 may also be used to inject lubricant, fuel, oil, and/or other material to be mixed through operation of the screw feeder 1302 within the central cavity of the sleeve 1308. In at least one embodiment, a dedicated gas port and a separate dedicated fluid/lubricant port may be arranged through the flanges 1312 and 1314. In one embodiment, the gas port 1313 is a threaded port. In one embodiment, the gas port 1313 includes a resealable quick-connection. In one embodiment, the gas port 1313 includes a manual control valve. In one embodiment, the gas port 1313 includes an automated and/or computer-controllable valve (e.g., a servo-operated ball valve, butterfly valve, or other valve as appropriate). Other variations may also be applicable.

FIG. 13B shows a cross-sectional view of the actively cooled gasifier screw feeder 103 in accordance with an embodiment of the invention. As illustrated, the secondary coolant path 1330 is defined by interior and exterior surfaces of the cooling sleeve 1308. Coolant is directed about the coolant path 1330 such that fuel fed into inlet 1311 is actively cooled and heat flows radially outward towards the inner walls 1332 of the coolant sleeve 1308.

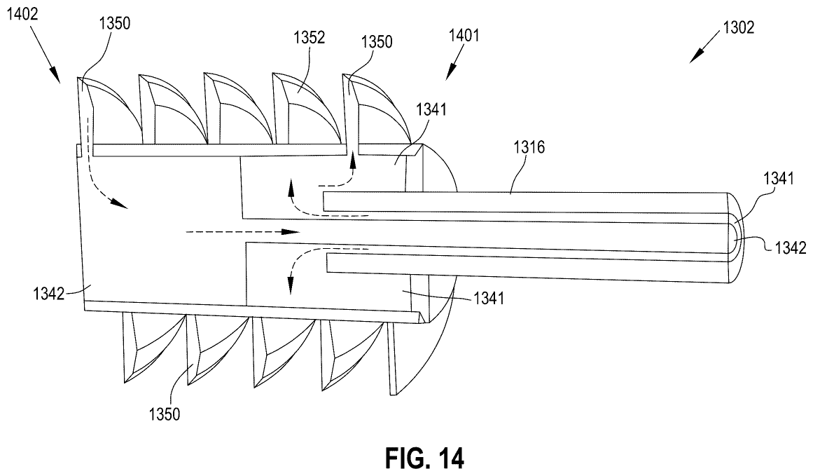

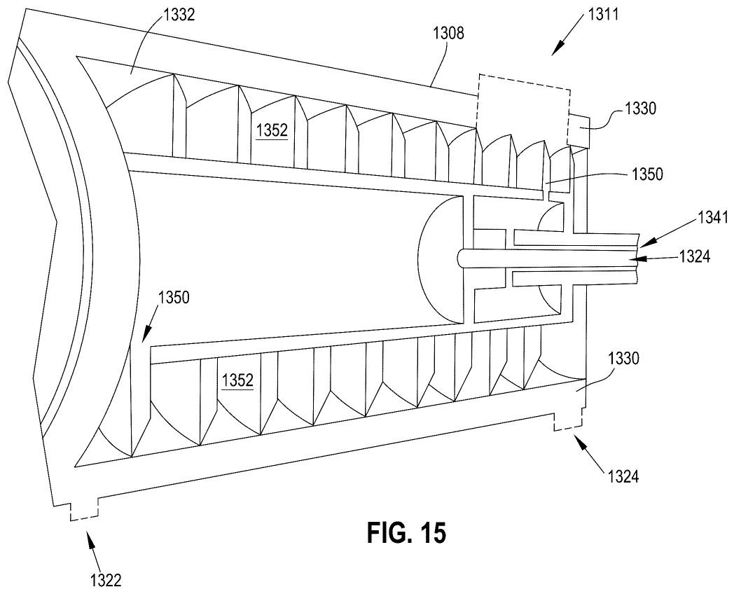

FIG. 13C shows an end-on cut-away view of the actively cooled gasifier screw feeder 103 in accordance with an embodiment of the invention. As illustrated, the secondary coolant path 1330 surrounds flights of the screw feeder 103. Additionally, and as will be described in more detail with reference to FIGS. 14-15, a primary coolant path is defined by interior walls of hollow flights of the screw feeder 1302. The primary coolant path 1330 is fed via a supply path 1341 and exits via a return path 1342. In this manner, heat is removed from fuel fed into inlet 1311 by both the primary and secondary coolant paths. Additionally, while in operation and while the screw feeder 103 is rotating, fuel brushes and makes physical contact with both exterior surfaces of the hollow flights and the interior surface 1332 of the cooling sleeve 1308. Accordingly, heat may flow radially outward from the fuel and radially inward towards the axle 1316, and this heat may be removed at a later stage once used coolant exits via respective return paths.

FIG. 14 shows a perspective cut-away view of the screw feeder 1302 with hollow flights in accordance with an embodiment of the invention. As illustrated, hollow flights 1350 form the primary coolant path described above. Coolant is supplied via supply path 1341 and is returned via return path 1342. It is noted that supply and return paths are relative, and therefore may be reversed from what is illustrated without departing from the scope of this disclosure. For example, coolant may either be supplied or returned via path 1341, and similarly may be supplied or returned via path 1342. As further illustrated, exterior surfaces 1352 of the hollow flights 1350 are arranged to make physical contact with fuel, and facilitate active cooling as described herein. In one embodiment, the screw feeder 1302 is formed from a steel alloy or stainless steel. In one embodiment, the screw feeder 1302 includes hollow flights throughout the cavity 1332 which extend at least partially into the exposed portion 1301. In one embodiment, coolant is arranged to circulate throughout the hollow flights 1350 disposed within the cavity 1332 and into at least a portion of the protruding portion 1301 of the screw feeder 1302. In some embodiments, the entirety of the screw feeder 1302 may be actively cooled. In some embodiments, only a portion of the protruding portion 1301 is actively cooled while a point, distal portion, or distal end of the protruding portion 1302 is not actively cooled. As further illustrated, the screw feeder 1302 comprises a first distal end portion 1401 and a second distal end portion 1402. It is noted that while protruding portion 1301 (illustrated in FIG. 13A) is an exterior distal portion of the screw feeder 1302, the first and second distal ends 1401 and 1402 are arranged to be within the cooling sleeve 1308. Furthermore, in operation, fuel is configured to be moved from the first distal end 1401 towards the second distal end 1402 while being actively cooled.

FIG. 15 shows a perspective cut-away view of the screw feeder 1302 arranged in coaxial relation with the annular cooling sleeve 1308 in accordance with an embodiment of the invention. As illustrated, hollow flights 1350 form the primary coolant path described above. Coolant is supplied via supply path 1341 and is returned via return path 1342. As further illustrated, exterior surfaces 1352 of the hollow flights 1350 are arranged to make physical contact with fuel, and facilitate active cooling as described herein. Additionally, interior surface 1332 of the annular cooling sleeve 1308 is arranged to make physical contact with fuel, and facilitate active cooling as described herein. Accordingly, dimensions of the screw feeder 1302 in relation to the interior surface 1332 are such that said dimensions prevent backflow of the fuel and promote a gas seal within the sleeve (e.g., against interior surface 1332). Additionally, although the hollow flights 1350 are illustrated as relatively triangular cross-sections with tips arranged to move proximate the inner surface 1332, the same may be varied by changing the cross-sectional profile of the hollow flights 1350. For example, flight tips of a ball or rounded design may be used such that the flights ride against the inner surface 1332. In other embodiments, the flight tips may be separate from and not physically contact the inner surface 1332. Furthermore, in embodiments where a lubricant or other fluid is injected along with fuel, the lubricant may lubricate the inner wall 1332 such that the flight tips are lubricated while riding against the surface 1332, reducing wear. Other variations are also applicable and embodiments are not limited to any particular hollow flight profile.

In some embodiments, the first and second coolant paths are arranged such that a combined 28,320 BTU of heat are removed per hour. Accordingly, dual actively cooled screw feeders may be arranged to remove up to a combined 56,640 BTU of heat per hour. It follows then that in a system employing multiple screw feeders 103, more than 40 tons of fuel per day may be expended while undergoing active cooling to ensure fuel temperatures do not exceed approximately 200° F. In some embodiments, fuel can be maintained at temperatures of between 40-250° F. while inside the screw feeder assembly 103. It is noted that extension of screw 1302 dimensions, increase of surface area (e.g., 1332, 1352) for physical contact, coolant choice, and other design variations within the ability of one or ordinary skill in the art of fuel feed systems may allow for increased range of fuel temperatures (i.e., improved cooling) according to any particular form of fuel to be transported. However, according to the particular illustrations provided, an embodiment of the actively cooled screw feeder is arranged to cool the chosen fuel below a threshold self-heating or pyrolysis initiation temperature while providing more than 40 tons of fuel per day.

Accordingly, as presented in FIGS. 13A-13C, as well as FIGS. 14-15, an actively cooled gasifier screw feeder 103 may include a first distal end portion 1401 and a second distal end portion 1402 opposite the first distal end portion. Additionally, the second distal end portion 1402 is arranged to provide a fuel into at least one of the one or more fuel feed inlets 201.

A screw feeder 1302 is disposed between the first distal end portion 1401 and the second distal end portion 1402. Furthermore, the screw feeder 1302 has a first coolant path 1350 arranged therethrough and the screw feeder 1302 is arranged to actively transport the fuel from the first distal end portion 1401 to the second distal end portion 1402, where it can be deposited into a gasification reactor or another screw feeder. Additionally, a sleeve 1308 is arranged in coaxial relation and about the screw feeder 1302. The sleeve 1308 has a second coolant path 1330 arranged therethrough. In some embodiments, the sleeve 1308 is an annular sleeve defining a hollow cylindrical cavity that serves as the second coolant path 1330.

FIG. 16 is a simplified schematic of a gasification reactor system 1600 fed with an actively cooled gasifier screw feeder 103 in accordance with an embodiment of the invention. As shown, the system 1600 may include a gasification reactor 299. For example, the gasification reactor may include a cylindrical reactor vessel, a fluidized bed, and/or one or more fuel feed inlets, as described in detail above. The system 1600 may further include a control system 1602 configured to receive data from one or more sensor components. The control system 1602 is further configured to provide control signals to several components such that steady state operation of the system 1600 may be achieved.

The system 1600 further includes a coolant reservoir 1604 in communication with the control system 1602. The coolant reservoir may be arranged to receive, store, and supply coolant to one or more coolant paths of the system 1600. In one embodiment, the coolant associated with the coolant reservoir 1604 is a propylene glycol-water mixture, an ethylene glycol-water mixture, or a combination of a propylene and ethylene glycol-water mixture. Other coolants are also applicable, depending upon desired cooling levels and/or inherent properties of a type of fuel fed into the reactor 299. For example, water, thermal oil, and other coolants may also be applicable.

The system 1600 further includes a coolant pump 1606 in communication with the control system 1602 and arranged in operative fluid communication with the coolant reservoir 1604. The coolant pump 1606 is arranged to pump coolant to/from the reservoir 1604 and is further arranged to pump coolant through one or more coolant paths of the system 1600.

The system 1600 further includes a motor and/or servomotor 1608 in communication with the control system 1602 and arranged in mechanical and rotational communication with an actively cooled screw feeder 1302. The motor 1608 is arranged to rotate the actively cooled screw feeder 1302 based on control signals received from the control system 1602.

The system 1600 further includes a heat exchanger or chiller 1610 in communication with the control system 1602 and in fluid communication with the annular cooling sleeve 1308 (e.g., secondary coolant path) and the screw feeder 1302 (e.g., primary coolant path) such that heat from one or both of the sleeve 1308 and feeder 1302 is at least partially removed from returned coolant. The coolant is returned to the coolant reservoir 1604 after being processed through the heat exchanger or chiller 1610. In an embodiment where component 1610 is a chiller, the coolant is returned to the coolant reservoir from the chiller, and temperature or operational characteristics of the chiller may be controlled by the control system 1602 such that an appropriate level of heat removal is obtained.

Accordingly, as presented above and illustrated in FIG. 16, as well as in FIGS. 13-15, a gasification reactor system 1600 may include, at least, a reactor vessel 299 and an actively cooled screw feeder 103 arranged to provide fuel to the reactor vessel 299. A coolant reservoir 1604 may be arranged to store, supply, and receive coolant from active coolant paths of the system 1600, based on operation of the coolant pump 1606. Furthermore, a control system 1602 may receive sensor data and further provide control signals to operate components of the system 1600.

It is noted that the control system 1602 may be arranged to perform a method of gasification of fuel according to any desirable, required, or established algorithm. The algorithm may include active cooling control based on properties of a particular fuel type, or fuel type combination, being fed into the reactor vessel 299.

Although multiple implementations have been described with reference to the Figures, other implementations are possible. For example, one or more additional coolant paths may be provided, coolant path shapes may be rearranged according to physical dimensions of a chosen cooling sleeve design, as well as differing pitch of hollow flights of a screw feeder are all possible. Furthermore, different coolants, lubricants, and even injectable coolants to be fed along with fuel are all possible variations. Additionally, altering a fuel dryer such that additional moisture is retained may provide interior lubrication of a screw feeder without departing from the scope of this disclosure.

Various fuel feed system implementations may achieve one or more technical effects. For example some implementations may reduce equipment cost and operator effort configuring and installing an exemplary system. Such reduced equipment cost and configuration effort may be a result of active cooling such that additional cumbersome designs for fuel feed handling and/or pre-cooling are unnecessary given the active removal of heat possible with the described multiple coolant paths. This results in a simplified installation that avoids having a separate handling step for conditioning recycled Class A seed material for drying such that a cooler initial temperature is achieved. Additionally, safety of gasification reactor systems is dramatically improved through implementation of an actively cooled gasifier screw feeder. For example, fuel is kept at or below a threshold self-heating or pyrolysis initiation temperature thereby reducing instances of smoldering fuel, wet fuel clogs, and other safety hazards associated with improper fuel temperature at a reactor fuel inlet. Moreover, when considering power generation with a gasification reactor, implementation of an actively cooled screw feeder may result in improved efficiency (e.g., due to decreased down-time for safety concerns, clogs, and maintenance) as well as improved output (e.g., due to decreased downtime in combination with improved reactor efficiency control when accounting for a stable fuel feed temperature). Other technical effects and benefits will be apparent to one or ordinary skill in the art of gasification reactor systems, including inherent benefits associated with stable fuel temperature and simplified control algorithms.

An exemplary implementation may comprise an actively cooled feeder system designed for a gasifier system to enable different feedstock materials to be fed to existing gasification reactors without having to custom design the feed system or integrate the feeder into the reactor, as well as reducing complexity of fuel handling due to temperature increases during fuel delivery using conventional screw feeder systems. An exemplary feeder system implementation may be combined with a fluidized bed gasification reactor for the treatment of multiple or mixed feedstocks including but not limited to sewage sludge, municipal solid waste, wood waste, refuse derived fuels, automotive shredder residue and non-recyclable plastics, thereby also illustrating a method of gasification for multiple and/or diverse feedstocks using a universal feeder system.

The feeder system consists of one or more feed vessels attached to at least one live bottom screw feeder. In one embodiment, the feed vessel is rectangular shaped having three vertical sides and an angled side of no less than 60 degrees from the horizontal to facilitate proper flow of bio-feedstock materials that have different and/or variable flow properties. The vessel also provides for aeration mechanisms such as provided by inserting removable bridge breakers to safeguard flows. The biosolids are transferred from the live bottom screw feeder through a chute and into a secondary transfer screw feeder with active cooling that conveys the material while cooling the material being fed to a feed nozzle operably connected to a gasifier reactor. Various feedstocks may be transferred through the open bottom chute to the live bottom screw feeder and through another open bottom chute to the transfer screw feeder that conveys feedstock to the fuel feed inlets of the gasifier. The secondary transfer screw may be equipped with two or more coolant paths to maintain a feed temperature between 60° F.-200° F. further expanding the types of feedstock that can be conveyed into a gasifier reactor.

An implementation in accordance with the teaching of the present disclosure may be used for receiving and conveying bio-feedstock materials into any bioreactor. The feeder system is specifically suitable for categories of waste currently being landfilled, that could be incinerated if permitting new incinerations were possible or that have restricted recycling options to safely and fully dispose of these waste materials. An implementation in accordance with the teaching of the present disclosure may be used by municipalities, landfill operators that clean up and rehabilitate land, waste generators, wastewater treatment facilities, agricultural waste generators, private waste service companies and entrepreneurs invested in renewable energy. Various implementations may also be used in analogous non-gasification processes to convey metered solids to storage tanks, for desegregation in recycling of waste.

An implementation in accordance with the teaching of the present disclosure may allow for standardizing equipment design and commoditization in the gasification industry by providing a path for simpler gasifier design with fewer equipment components. The feeder system may be used in open air, under ambient pressure and low temperature conditions. Where odor control is required, the systems can be fitted with a removable standard containment panel. In the case of biosolids, this design of the system may be a closed system from the feed bin into the gasifier to address odor control. Explosion panels are also optional for explosible dusts.

The present invention makes processing large volumes of feedstock in either a single- or multi-gasifier system and building large industrial facilities feasible and cost effective; replacing the current and commonly practiced use of multiple smaller units. More specifically, the present invention is an actively cooled feeder system that combines with a fluidized bed gasification reactor for the treatment of multiple diverse feedstocks including sewage sludge, municipal solid waste, wood waste, refuse derived fuels, automotive shredder residue and non-recyclable plastics. The invention thereby also illustrates a method of gasification for multiple and diverse feedstocks using a universal feeder system. The feeder system comprises one or more feed vessels and at least one live bottom screw feeder with active cooling.

The feed vessel may be rectangular shaped having three vertical sides and an angled side of no less than 60 degrees from the horizontal to facilitate proper flow of feedstock material that have different and/or variable flow properties. The feedstocks may be transferred through an open bottom chute to a live bottom screw feeder and through another open bottom chute to a transfer screw feeder that conveys feedstock to the fuel feed inlets of a gasifier. The invention may be advantageously used by the biomass waste processing industry. For example, various implementations may standardize the capacity scale to a single design from 10-24 tpd day to more than 40 tpd and an average of over 100 tpd of feedstock that can be used at a single facility and retain the economies of scale. It also cooperatively can work with other standard large-scale supporting equipment such as driers, pollution control equipment and thermal handling equipment. This allows for standardized system and equipment design and commoditization.

While various embodiments of the present invention have been described above, it should be understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be implemented to implement the desired features of the present invention. Additionally, with regard to operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

What is claimed is:

1. A gasification reactor system, comprising:
a gasification reactor comprising,
a cylindrical reactor vessel,
a fluidized bed section comprising at least a portion of the cylindrical reactor vessel, and
one or more fuel feed inlets arranged proximate the fluidized bed section; and
an actively cooled gasifier screw feeder comprising,
a first distal end portion and a second distal end portion opposite the first distal end portion, the second distal end portion arranged to provide a fuel into at least one of the one or more fuel feed inlets,
a screw feeder disposed between the first distal end portion and the second distal end portion, the screw feeder having a first coolant path arranged therethrough and the screw feeder arranged to actively transport the fuel from the first distal end portion to the second distal end portion,
a sleeve arranged in coaxial relation and about the screw feeder, the sleeve having a second coolant path arranged therethrough,
a coolant reservoir arranged to receive, store, and supply a coolant to the first and second coolant paths, and
a coolant pump in operative communication with the coolant reservoir and arranged to pump the coolant;
wherein the actively cooled gasifier screw feeder is configured to actively cool and feed the fuel into said cylindrical reactor vessel at a fuel feed rate based upon a type of the fuel and during steady-state operation of the gasification reactor system.

2. The gasification reactor system of claim 1, wherein the actively cooled gasifier screw feeder further comprises double bearings arranged proximate the first distal end portion or the second distal end portion and arranged to support the screw feeder in a cantilever arrangement.

3. The gasification reactor system of claim 1, wherein the first coolant path comprises hollow flights of the screw feeder.

4. The gasification reactor system of claim 1, wherein the sleeve is an annular sleeve, and wherein the second coolant path comprises a hollow cylindrical cavity defined by the annular sleeve.

5. The gasification reactor system of claim 1, wherein dimensions of the screw feeder prevent backflow of the fuel and promote a gas seal within the sleeve.

6. The gasification reactor system of claim 1, wherein the coolant is a propylene glycol-water mixture, an ethylene glycol-water mixture, or a combination of a propylene and ethylene glycol-water mixture.

7. The gasification reactor system of claim 1, wherein the first coolant path and the second coolant path are arranged to remove up to a combined 28,320 BTU/hr.

8. The gasification reactor system of claim 1, wherein the actively cooled gasifier screw feeder is a first actively cooled gasifier screw feeder, the gasification system further comprising a second actively cooled gasifier screw feeder, and the first and second actively cooled gasifier screw feeders are arranged to remove up to a combined 56,640 BTU/hr.

9. The gasification reactor system of claim 1, wherein the actively cooled screw feeder is arranged to cool the fuel below a threshold self-heating or pyrolysis initiation temperature.

10. The gasification reactor system of claim 1, wherein the screw feeder and sleeve are formed from a steel alloy or stainless steel.

11. An actively cooled gasifier screw feeder, comprising:
a first distal end portion and a second distal end portion opposite the first distal end portion, the second distal end portion arranged to provide a fuel for input into a gasification reactor vessel;
a screw feeder disposed between the first distal end portion and the second distal end portion, the screw feeder having a first coolant path arranged therethrough and the screw feeder arranged to actively transport the fuel from the first distal end portion to the second distal end portion;
a sleeve arranged in coaxial relation and about the screw feeder, the sleeve having a second coolant path arranged therethrough;
a coolant reservoir arranged to receive, store, and supply a coolant to the first and second coolant paths; and
a coolant pump in operative communication with the coolant reservoir and arranged to pump the coolant;
wherein the actively cooled gasifier screw feeder is configured to actively cool and feed the fuel into the gasification reactor vessel at a fuel feed rate based upon a type of the fuel and during steady-state operation of the gasification reactor vessel.

12. The actively cooled gasifier screw feeder of claim 11, further comprising double bearings arranged proximate the first distal end portion or the second distal end portion and arranged to support the screw feeder in a cantilever arrangement.

13. The actively cooled gasifier screw feeder of claim 11, wherein the first coolant path comprises hollow flights of the screw feeder.

14. The actively cooled gasifier screw feeder of claim 11, wherein the sleeve is an annular sleeve, and wherein the second coolant path comprises a hollow cylindrical cavity defined by the annular sleeve.

15. The actively cooled gasifier screw feeder of claim 11, wherein dimensions of the screw feeder prevent backflow of the fuel and promote a gas seal within the sleeve.

16. The actively cooled gasifier screw feeder of claim 11, wherein the coolant is a propylene glycol-water mixture, an ethylene glycol-water mixture, or a combination of a propylene and ethylene glycol-water mixture.

17. The actively cooled gasifier screw feeder of claim 11, wherein the first coolant path and the second coolant path are arranged to remove up to a combined 28,320 BTU/hr.

18. The actively cooled gasifier screw feeder of claim 11, wherein the actively cooled screw feeder is arranged to cool the fuel below a threshold self-heating or pyrolysis initiation temperature.

19. The actively cooled gasifier screw feeder of claim 11, wherein the screw feeder and sleeve are formed from a steel alloy or stainless steel.

20. An actively cooled gasifier screw feeder, comprising:
a first distal end portion and a second distal end portion opposite the first distal end portion, the second distal end portion arranged to provide a fuel for input into a flange arranged on a surface of a gasification reactor vessel;
a screw feeder disposed between the first distal end portion and the second distal end portion, the screw feeder having hollow flights and a central axial cavity defining a first coolant path, and the screw feeder arranged to actively transport the fuel from the first distal end portion to the second distal end portion through physical contact of the fuel with exterior surfaces of the hollow flights;
an annular sleeve arranged in coaxial relation and about the screw feeder, the annular sleeve having a hollow cavity defining a second coolant path;
a coolant reservoir arranged to receive, store, and supply a coolant to the first and second coolant paths; and
a coolant pump in operative communication with the coolant reservoir and arranged to pump the coolant;
wherein the actively cooled gasifier screw feeder is configured to actively cool and feed the fuel into the flange during steady-state operation of the gasification reactor vessel.
